(19) United States
(12) Patent Application Publication
(10) Pub. No.: US 2026/0302005 A1
(43) Pub. Date: Oct. 1, 2026

(54) CHIP RESISTOR

(71) Applicant: KOA CORPORATION, Ina-shi (JP)

(72) Inventors: Yasuhito TANAKA, Ina-shi (JP); Kaede YASUE, Ina-shi (JP)

(73) Assignee: KOA CORPORATION, Ina-shi (JP)

(21) Appl. No.: 19/632,919

(22) Filed: Mar. 30, 2026

(30) Foreign Application Priority Data
Mar. 28, 2025 (JP) 2025-057273

(51) Int. Cl. H01C 7/00; H01C 1/142

(52) U.S. Cl. CPC H01C 7/003; H01C 1/142

(57) ABSTRACT

A chip resistor 1 includes an insulating substrate 2 having first and second directions orthogonal to each other; a pair of front electrodes 3 provided on an upper surface of the insulating substrate 2 at both end portions along the first direction; a resistive element 5 bridging the pair of front electrodes 3; and a pair of end face electrodes 7 provided on both end faces of the insulating substrate 2 along the first direction. Each front electrode 3 includes a bridge region 3a extending at a constant width along the second direction on a side connected to the resistive element 5, and a slit 3b extending between an end face of the insulating substrate 2 and the bridge region 3a. Both ends of the resistive element 5 along the first direction contact a boundary line between the bridge region 3a and the slit 3b.

### TECHNICAL FIELD

The present invention relates to a chip resistor.

### BACKGROUND ART

A chip resistor mainly includes a rectangular parallelepiped insulating substrate, a pair of front electrodes that is disposed opposite to each other on the upper surface of the insulating substrate with a predetermined spacing therebetween, a resistive element that bridges the pair of front electrodes, an insulating protective film that covers the resistive element, a pair of back electrodes that is disposed opposite to each other on the lower surface of the insulating substrate with a predetermined spacing therebetween, and a pair of end face electrodes that extends on both the end faces of the insulating substrate and bridges the front electrodes and the back electrodes (for example, see Patent Literature 1).

In typical cases, for manufacturing a chip resistor of this type, a plurality of electrodes, resistive elements, and protective films are formed on a sheet-shaped and large-sized substrate, and then the large-sized substrate is divided along grid pattern partition lines into chip-shaped insulating substrates, so as to obtain a plurality of chip resistors. In the chip resistor thus obtained, the pair of front electrodes is formed to have rectangular shapes at both the ends of the insulating substate, respectively, and both the ends of the resistive element are connected to the inner ends of the front electrodes.

### CITATION LIST

### Patent Literature

Patent Literature 1: JP-A-2019-197801

### SUMMARY OF INVENTION

### Technical Problem

In recent years, there has been a growing demand for effective utilization of limited resources, while the prices of mineral resources such as electrode materials and resistor materials continue to rise. In this situation, efficient use of resources based on Sustainable Development Goal 12 (Responsible Production and Consumption) is becoming increasingly important. Electrodes provided on chip resistors widely utilize materials primarily composed of silver (Ag) or alloy materials containing palladium (Pd) in silver, and thus reducing the electrode area allows for reduction in these electrode materials. However, while reducing the electrode area enables reduction in electrode material, it also causes the problem of an unstable connection between the electrodes and the resistive element. Particularly, as chip resistors become smaller, the area occupied by the electrodes on the surface of the insulating substrate becomes significantly smaller, raising concerns that even a slight misalignment of the resistive element could cause defects.

The present invention was made in view of the actual situation of the prior art, and its purpose is to provide a chip resistor that can reduce the amount of electrode materials while ensuring stable connection with a resistive element.

### Solution to Problem

In order to achieve the purpose described above, the present invention provides a chip resistor comprising: a rectangular parallelepiped insulating substrate having a first direction and a second direction orthogonal to each other; a pair of front electrodes provided on an upper surface of the insulating substrate at both end portions thereof along the first direction; a rectangular resistive element bridging between the pair of front electrodes; and a pair of end face electrodes provided on both end faces along the first direction of the insulating substrate, wherein each of the pair of front electrodes includes a bridge region extending at a constant width along the second direction of the insulating substrate at a connecting side with the resistive element, and a notched portion extending between an end face of the insulating substrate and the bridge region, and both ends of the resistive element along the first direction are in contact with a boundary line between the bridge region and the notched portion.

### Advantageous Effects of Invention

According to the present invention, it is possible to reduce the amount of electrode materials while ensuring stable connection with a resistive element.

### BRIEF DESCRIPTION OF DRAWINGS

FIG. 1 is a top view of a chip resistor according to the first embodiment of the present invention.

FIG. 2 is a cross-sectional view along a line II-II of FIG. 1.

FIG. 3 is a cross-sectional view along a line III-III of FIG. 1.

FIG. 4 is an explanatory view of front electrodes and a resistive element provided in the chip resistor.

FIG. 5 is a top view illustrating a manufacturing process of the chip resistor.

FIG. 6 is a cross-sectional view illustrating a manufacturing process of the chip resistor.

FIG. 7 is a top view illustrating a main portion of a chip resistor according to the second embodiment of the present invention.

FIG. 8 is a top view illustrating a main portion of a chip resistor according to the third embodiment of the present invention.

FIG. 9 is a top view illustrating a main portion of a chip resistor according to the fourth embodiment of the present invention.

### DESCRIPTION OF EMBODIMENTS

Hereinafter, embodiments of the invention will be described with reference to the drawings.

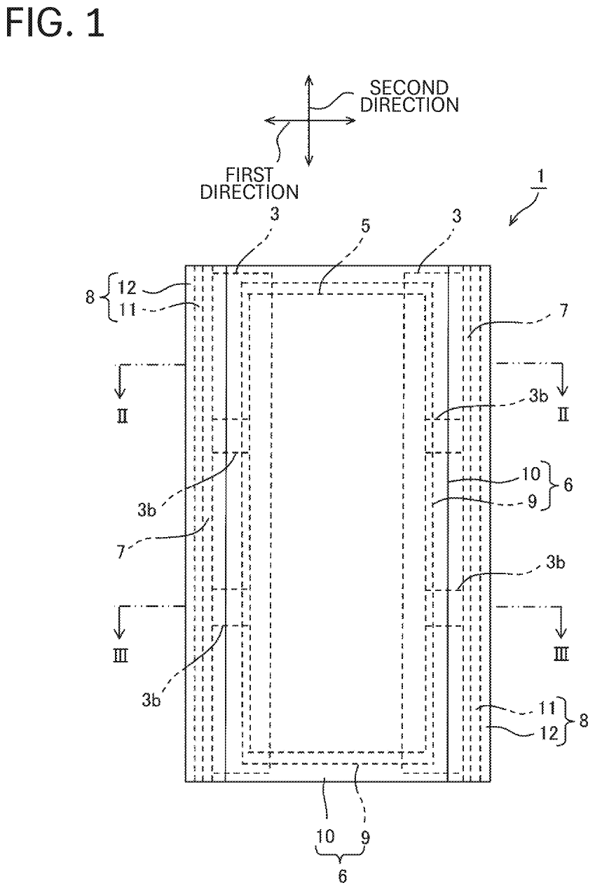

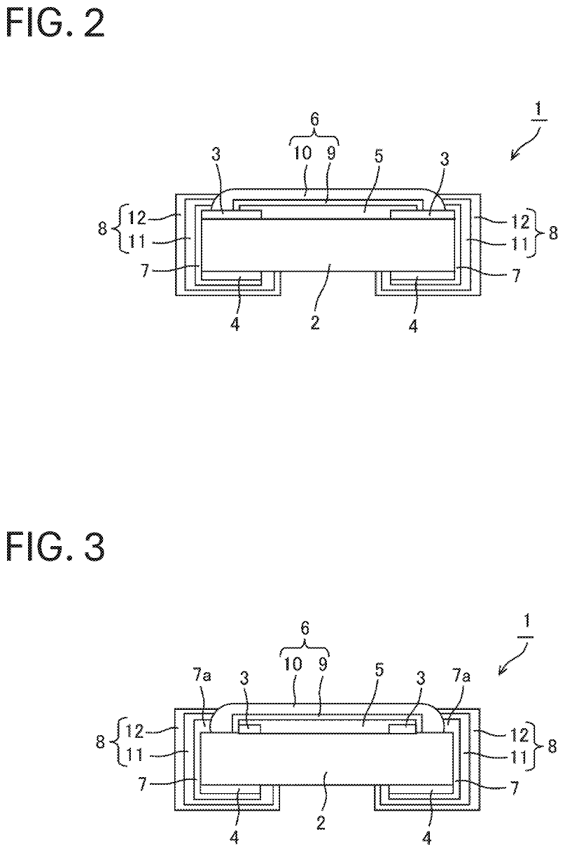

FIG. 1 is a top view of a chip resistor according to the first embodiment of the present invention, FIG. 2 is a cross-sectional view along a line II-II of FIG. 1, FIG. 3 is a cross-sectional view along a line III-III of FIG. 1.

As illustrated in FIG. 1 to FIG. 3, the chip resistor 1 according to the present embodiment includes a rectangular parallelepiped insulating substrate 2, a pair of front electrodes 3 provided on the upper surface of the insulating substrate 2 at both end portions in the short-side direction, a pair of back electrodes 4 provided on the lower surface of the insulating substrate 2 at both the end portions in the short-side direction, a resistive element 5 provided so as to extend over the pair of front electrodes 3, an insulating protective film 6 covering not only the resistive element 5 but also connection portions thereof with the front electrodes 3, a pair of end face electrodes 7 extending on the insulating substrate 2 at both the end faces in the short-side direction and electrically connecting between the front electrodes 3 and corresponding back electrodes 4, and a pair of external plating layers 8 provided so as to cover the end face electrodes 7.

The insulating substrate 2 is made of ceramics or the like. For obtaining the insulating substrate 2, a large-sized substrate, which will be described later, is divided into a plurality of pieces by splitting it along primary and secondary partition grooves extending vertically and horizontally. Hereinafter, among the mutually orthogonal axis directions of the insulating substrate 2, the direction in which the pair of front electrodes 3 is arranged is referred to as “first direction,” and the direction orthogonal to the first direction is referred to as “second direction.” Therefore, in the chip resistor 1 according to the present embodiment, the short axis direction of the insulating substrate 2 is the “first direction,” and the long axis direction of the insulating substrate 2 is the “second direction.”

The pair of front electrodes 3 is formed by screen-printing an Ag (silver) paste, followed by drying and firing. The front electrodes 3 are formed on the upper surface of the insulating substrate 2 at both the ends along the first direction, respectively, with a predetermined spacing therebetween. The back electrodes 3 are formed by screen-printing an Ag paste, followed by drying and firing. The back electrodes 3 are formed on the lower surface of the insulating substrate 2 at both the ends along the first direction, respectively, with a predetermined spacing therebetween.

The resistive element 5 is formed by screen-printing a resistive paste such as ruthenium oxide, followed by drying and firing, and is shaped as a rectangle with the second direction as its long axis. Both end portions of the long side along the first direction of the resistive element 5 overlap bridge regions 3a of the front electrodes 3, which will be described later.

The protective film 6 has a two-layer structure consisting of an undercoat layer 9 and an overcoat layer 10. The undercoat layer 9 is formed by screen-printing a glass paste, followed by firing, and is shaped as a rectangle to cover the whole resistive element 5. The overcoat layer 10 is formed by screen-printing an epoxy-based resin paste, followed by heat-curing, and is shaped as a rectangle to cover the whole undercoat layer 9. For adjustment of a resistance value of the resistive element 5, a trimming groove may be formed on the resistive element 5 from above the undercoat layer 9.

The end face electrodes 7 are formed by sputtering nickel(Ni)/chromium(Cr) or the like. The end face electrodes 7 electrically connect between the front electrodes 3 and the back electrodes 4, which are separated via the end faces of the insulating substrate 2.

Each of the external plating layers 8 includes a two-layer structure consisting of an inner barrier layer 11 and an outer external connection layer 12 covering the barrier layer 11. The barrier layer 11 is an Ni plating layer formed by electroplating, covering the whole surface of the end face electrode 7. The external connection layer 12 is an Sn plating layer formed by electroplating, covering the whole surface of the barrier layer 11.

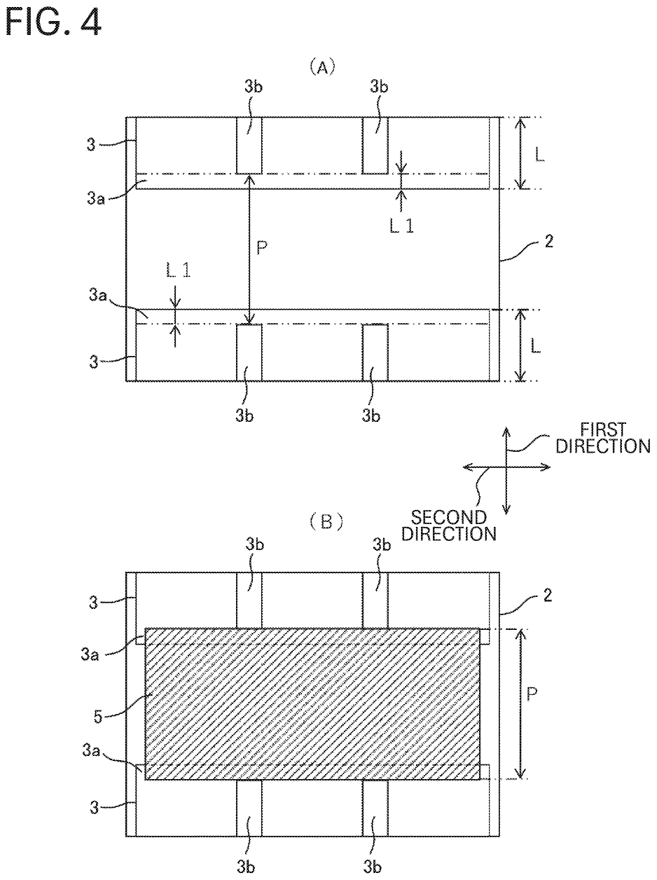

FIG. 4 is an explanatory view of the front electrodes 3 and the resistive element 5. FIG. 4(A) illustrates the front electrodes 3, and FIG. 4(B) illustrates the connection state between the front electrodes 3 and the resistive element 5.

As illustrated in FIG. 4(A), the front electrode 3 includes the bridge region 3a, which is the connection point with the resistive element 5, and a plurality of slits 3b extending from the end face of the insulating substrate 2 toward the bridge region 3a. The bridge region 3a extends along the second direction of the insulating substrate 2 with a constant width. Viewed as a whole, the front electrode 3 is formed in a comb-like pattern, with the amount of electrode materials reduced by the number of slits 3b.

Here, the total length of the front electrode 3 along the first direction is defined as L and the length (width dimension) of the bridge region 3a along the first direction is defined as L1. The width dimension L1 of the bridge region 3a is set within the range where it is greater than 1/20 of the total length L of the front electrode 3 but less than ½ (L/20<L1<L/2). In the present embodiment, to ensure stable connection with the resistive element 5, the width dimension L1 of the bridge region 3a is set within the range of 20 μm to 300 μm. The distance between the opposing slits 3b formed in the pair of front electrodes 3 is defined as P.

As illustrated in FIG. 4(B), the resistive element 5 is formed so that it overlaps the bridge regions 3a of the front electrodes 3. Both ends of the long sides of the resistive element 5 along the first direction are formed to be in contact with the boundary lines between the bridge regions 3a of the front electrodes 3 (portions indicated by two-dot lines in FIG. 4(A)) and the slits 3b. In this case, the total length (short-side length) P of the resistive element 5 along the first direction is set to be equal to the distance P between the two opposing slits 3b of the pair of front electrodes 3. When the resistive element 5 is formed in the correct position relative to the front electrodes 3, both the ends of the long sides of the resistive element 5 are located on the boundary lines between bridge regions 3a and the slits 3b. Therefore, even if the bridge region 3a is exposed between the end of the resistive element 5 and the slit 3b of the front electrode 3, it is visually possible to determine that the resistive element 5 is misaligned relative to the front electrode 3.

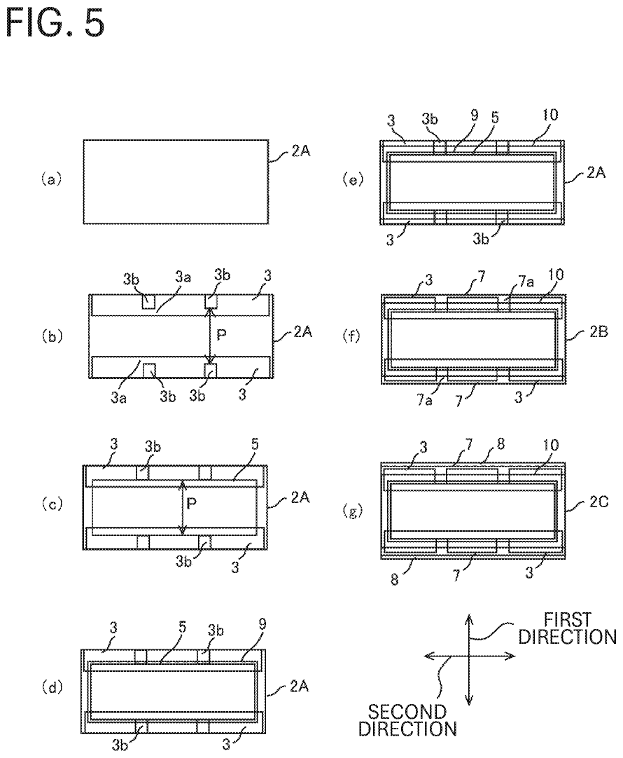

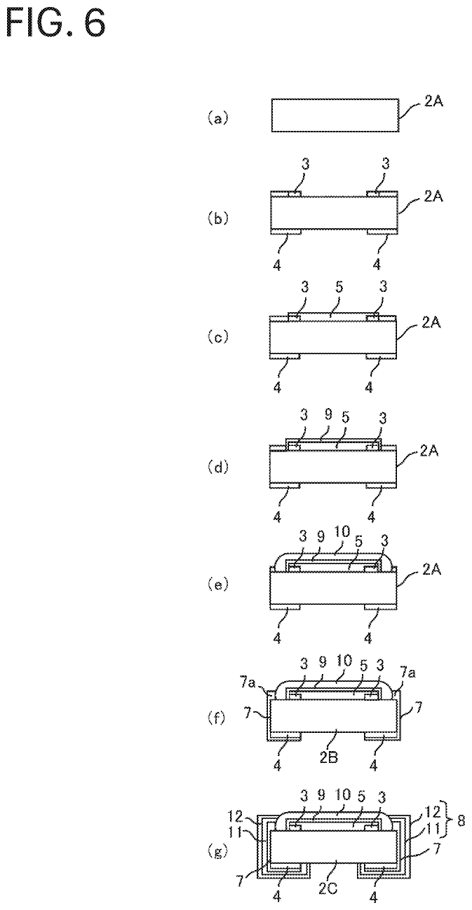

Next, a manufacturing method for the chip resistor 1 configured as described above will be explained. FIG. 5 is a top view illustrating the manufacturing process of the chip resistor 1, and FIG. 6 is a cross-sectional view illustrating the manufacturing process of the chip resistor 1.

First, as illustrated in FIG. 5(a) and FIG. 6(a), a large-sized substrate 2A with primary partition grooves and secondary partition grooves extending in a grid pattern is prepared. These primary and secondary partition grooves are used to divide both the front and back surfaces of the large-sized substrate 2A into a plurality of chip formation areas, each of which becomes one insulating substrate 2. Each of FIG. 5 and FIG. 6 illustrates one chip formation area as representative, but in practice, such a plurality of chip formation areas is arranged in a grid pattern.

Next, as illustrated in FIG. 5(b) and FIG. 6(b), an Ag paste is screen-printed onto the lower surface of the large-sized substrate 2A. This paste is then dried and fired to form the pair of back electrodes 4 which is positioned at opposite ends of the first direction of each chip formation area and spaced apart by a predetermined distance. Around the same time, an Ag-based paste is screen-printed onto the upper surface of the large-sized substrate 2A. This paste is then dried and fired to form the pair of front electrodes 3 at both the ends of the first direction of each chip formation area, facing each other with a predetermined spacing therebetween. Each of these front electrodes 3 is formed in a comb-like shape having the bridge regions 3a and the plurality of slits 3b, such that the opposing distance P between the slits 3b of each of the front electrodes 3s is maintained.

Next, a resistive paste containing ruthenium oxide or the like is screen-printed onto the upper surface of the large-sized substrate 2A. This paste is then dried and fired to form a rectangular resistive element 5, as illustrated in FIG. 5(c) and FIG. 6(c), with both the ends overlapping onto the bridge regions 3a of the front electrodes 3. In this process, the total length (short-side length) P of the resistive element 5 along the first direction is set equal to the distance P between the opposing slits 3b. Furthermore, printing is performed with the boundary lines between the slits 3b and the bridge regions 3a being aligned. Consequently, when the resistive element 5 is formed in the correct position relative to the front electrodes 3, the resistive element 5 is formed with both the ends on its long sides contacting the boundary lines between the bridge regions 3a and the slits 3b. During printing of the resistive element 5, the resistive paste may slightly enter the slit 3b beyond the bridge region 3a depending on its viscosity. In such cases, the short-side length of the formed resistive element 5 becomes slightly larger than the opposing distance P between the slits 3b.

Next, as illustrated in FIG. 5(d) and FIG. 6(d), a glass paste is screen-printed onto the area covering the resistive element 5. This paste is then dried and fired to form the undercoat layer 9 that covers the whole resistive element 5, including the connection ends with the front electrodes 3. In the case where it is necessary to adjust the resistance value of the resistive element 5, a trimming groove can be formed in the resistive element 5 by irradiating laser light onto the undercoat layer 9.

Next, as illustrated in FIG. 5(e) and FIG. 6(e), a resin paste such as epoxy is screen-printed onto the undercoat layer 9. This paste is then heated and cured (baked) to form the overcoat layer 10 which overlaps the undercoat layer 9. Thus, the two-layer protective film 6 composed of the undercoat layer 9 and the overcoat layer 10 is produced, with the inner edges near the bridge region 3a of the slits 3b being filled with the portions of the protective film 6.

The processes described above are performed collectively for the large-sized substrate 2A. In the subsequent processes, the large-sized substrate 2A is preliminarily divided into strip-shaped sections along the primary partition grooves, yielding strip-shaped substrates 2B whose width dimension corresponds to the first direction of the chip formation area.

Next, as illustrated in FIG. 5(f) and FIG. 6(f), by sputtering Ni/Cr toward the partition faces (end faces) of the strip-shaped substrate 2B, the pair of end face electrodes 7 for electrically connecting between the front electrodes 3 and the back electrodes 4 is formed. During this process, some sputtered particles adhere within the slits 3b of the front electrodes 3. Consequently, upper surface connection portions 7a, which electrically connect to the front electrodes 3 within the slits 3b, are formed on the end face electrodes 7.

Next, the strip-shaped substrate 2B is secondarily divided along the secondary partition groove to obtain a plurality of chip-shaped substrates 2C. Then, electrolytic Ni plating and electrolytic Sn plating are sequentially applied to the chip-shaped substrates 2C to form a two-layer external plating layers 8 (barrier layer 11 and external connection layer 12), as illustrated in FIG. 5(g) and FIG. 6(g). This yields the chip resistor 1 as illustrated in FIG. 1 to FIG. 3. In FIG. 5(c) to FIG. 5(g), the components including the front electrodes 3, the resistive element 5, and the protective film 6 are depicted as perspective views to clearly illustrate the positional relationships therebetween.

As described above, the chip resistor 1 according to the present embodiment includes: a rectangular parallelepiped insulating substrate 2 having a first direction and a second direction orthogonal to each other; a pair of front electrodes 3 provided on an upper surface of the insulating substrate 2 at both end portions thereof along the first direction; a rectangular resistive element 5 bridging between the pair of front electrodes 3; and a pair of end face electrodes 7 provided on both end faces along the first direction of the insulating substrate 2, wherein each of the pair of front electrodes 3 includes a bridge region 3a extending at a constant width along the second direction of the insulating substrate 2 at a connecting side with the resistive element 5, and a slit (notched portion) 3b extending between an end face of the insulating substrate 2 and the bridge region 3a, and both ends of the resistive element 5 along the first direction are in contact with a boundary line at an inner end face of the slit 3b in the first direction. According to the configuration described above, providing the slits 3b in the front electrodes 3 enables elimination of the areas of low current density, thereby reducing the amount of electrode materials required. Furthermore, a stable connection between the front electrodes 3 and the resistive element 5 can be ensured.

In the configuration described above, the ratio of the bridge region 3a relative to the whole front electrode 3 is not particularly limited. Preferably, however, where the total length of the front electrode 3 along the first direction is defined as L and the length (width dimension) of the bridge region 3a along the first direction is defined as L1, the width dimension L1 of the bridge region 3a is set within a range greater than ½ of the total length L of the front electrode 3 but less than ½ (L/20<L1<L/2). Thus, setting the width dimension L1 of the bridge region 3a to a value smaller than L/2 can further enhance the reduction effect of electrode materials.

In this case, when the width dimension L1 of the bridge region 3a is set within a range between 20 μm to 300 μm, a stable connection between the front electrodes 3 and the resistive element 5 can be ensured even in the chip resistor 1 having the reduced external dimensions.

Furthermore, in the chip resistor 1 according to the present embodiment, the slit 3b extending to the bridge region 3a, starting from the end face of the insulating substrate 2 is formed in the front electrode 3, and each of the end face electrodes 7 includes an upper surface connection portion 7a formed inside the slit 3b and electrically connects with a corresponding one of the front electrodes 3. This can increases the connection areas between the front electrodes 3 and the end face electrodes 7.

Still further, in the chip resistor 1 according to the present embodiment, in the connection between the front electrodes 3 and the resistive element 5, the resistive element 5 is formed so that it overlaps the bridge regions 3a of the front electrodes 3. Both the ends of the resistive element 5 in the first direction are formed so that they are in contact with the boundary line between the bridge regions 3a and the slits 3 of the front electrodes 3b. Therefore, the bridge regions 3a are not exposed between the ends of the resistive element 5 and the slits 3b of the front electrodes 3. This enables the connection between the front electrodes 3 and the resistive element 5 to be made with a minimum amount of electrode materials, without forming any wasteful areas of electrode materials.

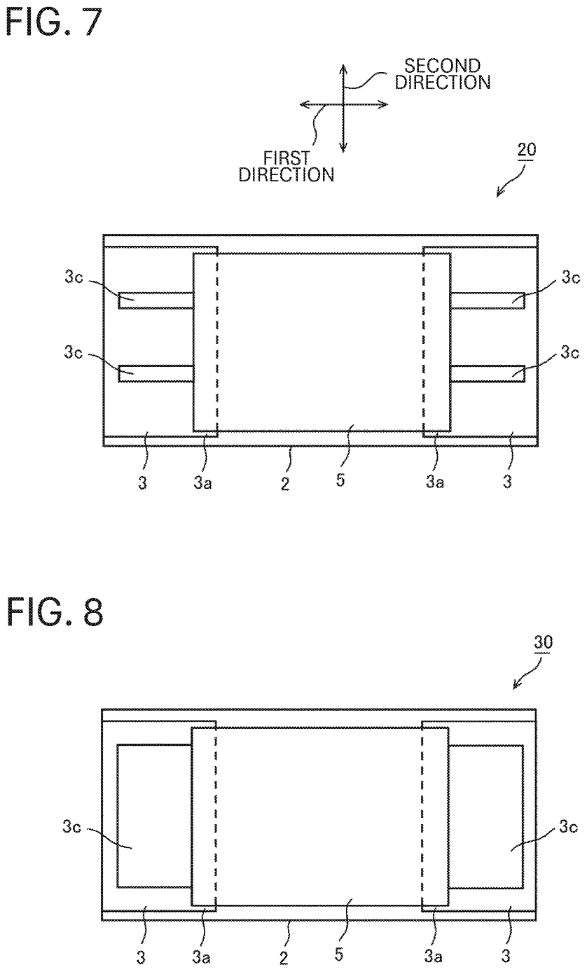

FIG. 7 is a top view illustrating a main portion of a chip resistor 20 according to the second embodiment of the present invention.

As illustrated in FIG. 7, in the chip resistor 20 according to the second embodiment, the pair of front electrodes 3 is provided on the upper surface of the insulating substrate 2 at both longitudinal ends thereof, with the long-axis direction of the insulating substrate 2 being the “first direction” and the short-axis direction of the insulating substrate 2 being the “second direction”. Furthermore, the front electrodes 3 include the bridge regions 3a serving as the connection points with the resistive element 5, and a plurality of cutout holes 3c (notched portions) formed between positions spaced away from the end faces of the insulating substrate 2 and the bridge regions 3a. The amount of electrode materials is reduced by the number of cutout holes 3c. The remaining configuration is the same as that of the chip resistor 1 according to the first embodiment.

FIG. 8 is a top view illustrating a main portion of a chip resistor 30 according to the third embodiment of the present invention.

As illustrated in FIG. 8, in the chip resistor 30 according to the third embodiment, the cutout holes 3c extending lengthwise along the second direction of the insulating substrate 2 are formed in the front electrodes 3. By increasing the area of the cutout holes 3c in the second direction in this manner, the amount of electrode materials can be significantly reduced and stable connection between the front electrodes 3 and the resistive element 5 can be ensured in the bridge regions 3a.

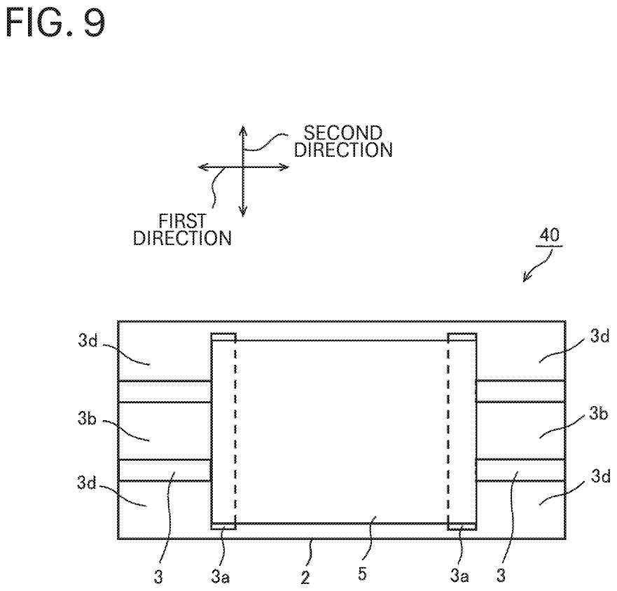

FIG. 9 is a top view illustrating a main portion of a chip resistor 40 according to the fourth embodiment of the present invention.

As illustrated in FIG. 9, in the chip resistor 40 according to the fourth embodiment, one of the pair of front electrodes 3 has both ends in the second direction formed as cutout portions 3d (notched portions) lacking electrode materials, and a slit 3b with a longer dimension along the second direction is formed within the front electrode 3. By forming the cutout portions 3d lacking the electrode material at the ends in the second direction of the front electrode 3 and enlarging the area of the slit 3b in the second direction formed within the front electrode 3, the amount of electrode materials can be significantly reduced and a stable connection between the front electrodes 3 and the resistive element 5 can be ensured in the bridge area 3a.

The present invention is not limited to the embodiments described above, and various modifications can be made within the scope of the concept of the present invention. All technical matters included in the technical concept described in the claims are the subject matter of the present invention. The embodiments described above are preferred examples, however, those skilled in the art would recognize that various alternative, modified, or improved examples can be realized based on the disclosure in this specification, and these are included within the technical scope described in the appended claims.

For example, in the first and second embodiments described above, the plurality of slits 3b and the plurality of notched holes 3c are formed in the front electrodes 3. However, the number and size of these slits 3b and notched holes 3c are not limited thereto. Furthermore, slits or notches may also be formed in the back electrodes 4.

The present invention achieves the effect of ensuring stable connection with a resistive element while reducing the amount of electrode materials used. As a result, it contributes to SDG, Goal 12 “Responsible Consumption and Production” through effects such as the sustainable management of natural resources.

### REFERENCE SIGNS LIST

1, 20 chip resistor
2 insulating substrate
2A large-sized substrate
2B strip-shaped substrate
2C chip-shaped substrate
3 front electrode
3a bridge region
3b slit (notched portion)
3c notched hole (notched portion)
3d cutout portion (notched portion)
4 back electrode
5 resistive element
6 protective film
7 end face electrode
7a upper surface connection portion
8 external plating electrode
9 undercoat layer
10 overcoat layer
11 barrier layer
12 external connection layer

1. A chip resistor comprising:
a rectangular parallelepiped insulating substrate having a first direction and a second direction orthogonal to each other;
a pair of front electrodes provided on an upper surface of the insulating substrate at both end portions thereof along the first direction;
a rectangular resistive element bridging between the pair of front electrodes; and
a pair of end face electrodes provided on both end faces along the first direction of the insulating substrate, wherein
each of the pair of front electrodes includes a bridge region extending at a constant width along the second direction of the insulating substrate at a connecting side with the resistive element, and a notched portion extending between an end face of the insulating substrate and the bridge region, and
both ends of the resistive element along the first direction are in contact with a boundary line between the bridge region and the notched portion.

2. The chip resistor according to claim 1, wherein
where an entire length of each of the front electrodes along the first direction is defined as L and a length of the bridge region along the first direction is defined as L1, L/20<L1<L/2 is set.

3. The chip resistor according to claim 2, wherein
L1 is set within a range between 20 μm to 300 μm.

4. The chip resistor according to claim 1, wherein
the notched portion is a slit extending to the bridge region, starting from the end face of the insulating substrate, and
each of the end face electrodes includes an upper surface connection portion formed inside the slit and electrically connects with a corresponding one of the front electrodes.

5. The chip resistor according to claim 1, wherein
the notched portion is a cutout hole formed between a position away from the end face of the insulating substrate and the bridge region.

6. The chip resistor according to claim 4, wherein
the notched portion includes a plurality of notched portions, and
the plurality of notched portions is formed along the second direction of the insulating substrate with a predetermined spacing therebetween.

7. The chip resistor according to claim 5, wherein
the notched portion includes a plurality of notched portions, and
the plurality of notched portions is formed along the second direction of the insulating substrate with a predetermined spacing therebetween.
